(19) United States
(12) Patent Application Publication
(10) Pub. No.: US 2022/0250430 A1
(43) Pub. Date: Aug. 11, 2022

(54) MULTILINK MID-HEIGHT SUSPENSION ASSEMBLY FOR MOTOR VEHICLES

(71) Applicant: GM GLOBAL TECHNOLOGY OPERATIONS LLC, Detroit, MI (US)

(72) Inventor: Scott Kolp, Clarkston, MI (US)

(73) Assignee: GM GLOBAL TECHNOLOGY OPERATIONS LLC, Detroit, MI (US)

(21) Appl. No.: 17/173,782

(22) Filed: Feb. 11, 2021

(51) Int. Cl. B60G 7/00; B60G 3/20; B62D 7/18; B62D 7/22; B60G 7/02; B60G 21/055; B62D 65/12

(52) U.S. Cl. CPC B60G 7/008; B60G 2204/129; B62D 7/18; B62D 7/228; B60G 7/005; B60G 7/02; B60G 21/055; B62D 65/12; B60G 2204/148; B60G 2204/416; B60G 2204/143; B60G 2204/41; B60G 2204/418; B60G 2204/82; B60G 3/20

(57) ABSTRACT

A multilink suspension assembly for a motor vehicle includes a steering knuckle rotatably mounting thereon a wheel unit, and a tie bar mounted to a respective swivel joint of the steering knuckle. Two lower control links are located aft of the tie bar and have inboard ends mounted to respective mounting junctions on the vehicle chassis and outboard ends mounted to respective swivel joints at a lower end of the steering knuckle. Two upper control links, which are located aft of the tie bar and vertically spaced from the lower control links, have inboard ends mounted to respective mounting junctions on the vehicle chassis and outboard ends mounted to respective swivel joints at an upper end of the steering knuckle. The swivel joints mount the upper and lower control links to the steering knuckle inboard from the wheel unit and below an upper extent of the wheel unit's tire.

### INTRODUCTION

The present disclosure relates generally to suspension systems of motor vehicles. More specifically, aspects of this disclosure relate to multilink, mid-height front suspension assemblies.

Current production motor vehicles, such as the modern-day automobile, are originally equipped with a powertrain that operates to propel the vehicle and power the vehicle's onboard electronics. In automotive applications, for example, the powertrain is typified by an engine and/or motor that delivers driving torque through an automatic or manually shifted transmission to the vehicle's final drive system (e.g., differential, axle shafts, road wheels, etc.). During vehicle operation, a steering system allows the driver to maintain a desired course for the vehicle and to control the vehicle's directional changes. The steering system includes a hand-operated steering wheel that is mounted via a central hub to a steering column assembly. Telescoped shafts of the steering column connect the steering wheel with a road wheel steering mechanism, most commonly a rack-and-pinion steering architecture. When the steering wheel is rotated, a pinion gear at the distal end of a steering shaft concurrently spins, affecting a linear gear bar, known as a “rack,” to move transversely across the vehicle. A tie rod at each end of the rack is connected to the steering arm of a steering knuckle; the moving rack and tie rod pivot the knuckle to turn the wheel.

For most automotive drivelines, a vehicle wheel assembly is a pneumatic unit with a synthetic-rubber tire fitted onto the outer rim (“barrel”) of a metallic wheel. To ensure consistent road handling, steering, and braking, each wheel unit is connected, e.g., via wheel spokes and a central hub (collectively “wheel face”), to the vehicle chassis through a suspension system composed of a collaboration of springs, shock absorbers, and linkages. For instance, a front corner module of a conventional rear-wheel drive automobile employs a steering knuckle with a spindle onto which a hub and a brake rotor are rotatably mounted. Inboard contact points of the knuckle are coupled to the vehicle body, e.g., via a control arm, sway bar, strut damper, and tie rod, whereas the outboard end is coupled to the wheel hub, e.g., via the spindle and hub. The wheel unit rotates and steers on the knuckle, spindle, and tie rod, while being held in a stable plane of motion by the knuckle, strut, and spring.

### SUMMARY

Presented herein are multilink suspension systems for motor vehicles, methods for making and methods for using such suspension systems, and motor vehicles equipped with multilink, mid-height front suspension assemblies. By way of example, a front suspension assembly is presented that structurally mounts the steering knuckle and wheel unit to the vehicle chassis utilizing a five-point linkage arrangement with a set of lower control links, a set of upper control links, and a tie rod. An outboard end of each lower control link connects to an individual swivel point at the bottom of the steering knuckle, whereas an inboard end connects at a discrete location to the vehicle chassis (e.g., unibody mount or frame rail). Likewise, outboard ends of the upper control links connect to individual swivel points at the top of the steering knuckle, whereas inboard ends connect at discrete locations on the chassis. The upper control links are longitudinally spaced in a fore-aft direction from each other and vertically spaced from the lower control links. The tie bar, which is located inboard from the wheel unit and forward of all four control links, mechanically couples the steering knuckle to a steering rack, for example. An optional stabilizer link is connected at an outboard end thereof via a horizontal hinge pin to an inboard face of the steering knuckle adjacent the outboard connecting points of the upper control links. All outboard connecting points of the upper and lower control links are located inboard from the wheel unit and below an upper extent of the tire.

Attendant benefits for at least some of the disclosed concepts include a 5-link mid-arm front suspension architecture that enables a shortened spindle length geometry and concurrently reduces packaging space requirements, e.g., allowing for a lower engine hood profile and/or a larger tire diameter. Disclosed suspension systems also help to improve vehicle handling and steering system load by reducing caster trail and scrub change during steering. This is accomplished by increasing upper link joint spread to thereby reduce kingpin angle and kingpin geometry migration at ground with steer compared to other multilink front suspension arrangements. These options may be especially advantageous for full-electric vehicles (FEV) because: (1) FEVs do not have an internal combustion engine such that the forward hood may be markedly lowered; (2) high traction motor torque benefits from a low spindle length geometry; and (3) a current trend for electric-drive vehicles are large tire outer diameters (OD).

Aspects of this disclosure are directed to multilink, mid-height front suspension assemblies for motor vehicles. For example, a multilink suspension assembly includes a steering knuckle that rotatably mounts thereon a wheel unit, e.g., via an axle hub and bearing assembly. A tie bar link is mounted at an outboard end thereof to a dedicated swivel joint of the steering knuckle and at an inboard end thereof to a steering system actuator (e.g., a rack-and-pinion assembly). Multiple lower control links, which are located aft of the tie bar link, each has an inboard end that mounts to a dedicated mounting junction on the vehicle chassis and an outboard end that mounts to a dedicated swivel joint at a lower end of the steering knuckle. Likewise, multiple upper control links, which are located aft of the tie bar link and vertically spaced from the lower control links, each has an inboard end that mounts to a dedicated mounting junction on the vehicle chassis and an outboard end that mounts to a dedicated swivel joint at an upper end of the steering knuckle. The control link swivel joints mount the lower and upper control links to the steering knuckle inboard from the wheel unit and below an upper extent of the wheel unit's tire.

Additional aspects of this disclosure are directed to motor vehicles equipped with multilink, mid-height suspension assemblies. As used herein, the terms “vehicle” and “motor vehicle” may be used interchangeably and synonymously to reference any relevant vehicle platform, such as passenger vehicles (ICE, REV, FEV, fuel cell, fully and partially autonomous, etc.), commercial vehicles, industrial vehicles, tracked vehicles, off-road and all-terrain vehicles (ATV), motorcycles, farm equipment, aircraft, etc. In an example, a motor vehicle includes a vehicle chassis (e.g., unibody or body-on-frame construction) with a passenger compartment, multiple road wheel units, and other standard original equipment. A prime mover, which may be in the nature of an internal combustion engine (ICE) assembly and/or an electric traction motor unit, selectively drives one or more of the wheel units to thereby propel the vehicle.

Continuing with the discussion of the above example, the vehicle also includes multiple multilink suspension assemblies. Each suspension assembly includes a steering knuckle that rotatably mounts thereon one of the vehicle wheel units, and a tie bar link that is mounted to a respective swivel joint of the steering knuckle. Located aft of the tie bar is a pair of lower control links, each of which has an inboard end that is mounted to a respective mounting junction on the vehicle chassis and an outboard end that is mounted to a respective swivel joint at a lower end of the steering knuckle. Located aft of the tie bar and vertically spaced from the lower control links is a pair of upper control links, each of which has an inboard end that is mounted to a respective mounting junction on the vehicle chassis and an outboard end that is mounted to a respective swivel joint at an upper end of the steering knuckle. The control link swivel joints mount the upper and lower control links to the steering knuckle at locations inboard from the wheel unit and below an upper extent of the tire.

Aspects of this disclosure are also directed to manufacturing systems and methods for making any of the disclosed suspension assemblies and/or motor vehicles. In an example, a method is presented for manufacturing a multilink suspension assembly for a motor vehicle. This representative method includes, in any order and in any combination with any of the above and below disclosed options and features: mounting a tie bar link (TBL) to a TBL swivel joint of a steering knuckle, the steering knuckle configured to rotatably mount thereon the wheel unit; mounting a plurality of lower control links (LCL) to the steering knuckle aft of the tie bar link, each of the lower control links having a respective LCL inboard end configured to mount to a respective LCL mounting junction on the vehicle chassis and a respective LCL outboard end mounted to a respective LCL swivel joint at a lower end of the steering knuckle; and mounting a plurality of upper control links (UCL) to the steering knuckle aft of the tie bar link and vertically spaced from the lower control links, each of the upper control links having a respective UCL inboard end configured to mount to a respective UCL mounting junction on the vehicle chassis and a respective UCL outboard end mounted to a respective UCL swivel joint at an upper end of the steering knuckle, wherein the UCL and LCL swivel joints mount the upper and lower control links to the steering knuckle inboard from the wheel unit and below an upper extent of the tire.

For any of the disclosed suspension assemblies, methods, and vehicles, the outboard ends of the upper control links may be spaced from each other a first horizontal distance. In this instance, the inboard ends of the upper control links may be spaced from each other a second horizontal distance greater than the first horizontal distance such that the upper control links are arranged in a first V-shaped configuration. In the same vein, the outboard ends of the lower control links may be spaced from each other a third horizontal distance. In this instance, the inboard ends of the lower control links may be spaced from each other a fourth horizontal distance greater than the third horizontal distance such that the upper control links are arranged in a second V-shaped configuration.

For any of the disclosed suspension assemblies, methods, and vehicles, the outboard ends of the upper control links may be spaced inboard from the outboard ends of the lower control links. Likewise, the inboard ends of the upper control links may be spaced outboard from the inboard ends of the lower control links. As a further option, the control link mounting junctions on the vehicle chassis may each include a horizontal bushing pin; the inboard ends of the lower and upper control links may each include a bushing housing that receives therein one of the horizontal bushing pins. The control link swivel joints on the steering knuckle may each include a bearing stud of a spherical bearing. In this instance, the outboard ends of the lower and upper control links may each include a respective bearing socket that receives therein a spherical end of one of the bearing studs.

For any of the disclosed suspension assemblies, methods, and vehicles, the steering knuckle may be fabricated with a central hub that rotatably mounts to the wheel unit via an axle hub assembly. Multiple mounting arms may project radially outward from the central hub: a tie bar mounting arm includes a horizontal flange with the tie bar's swivel joint mounting thereto the tie bar link; a lower control link mounting arm includes a horizontal flange with the control links' swivel joints mounting thereto the lower control links; and an upper control link mounting arm includes a horizontal flange with the control links' swivel joints mounting thereto the upper control links.

For any of the disclosed suspension assemblies, methods, and vehicles, the multilink suspension assembly may include a stabilizer link that is pivotably mounted to the steering knuckle adjacent to the upper control link's swivel joints and extends downward from the upper control links. As a further option, the suspension assembly may include a shock absorber assembly and a shock yoke that couples the bottom end of the shock absorber assembly to one of the lower control links. In this instance, each of the upper control links is located on a respective side of the shock absorber assembly. It may be desirable that each control link be fabricated as a discrete component that is structurally distinct, e.g., in length and shape from the other control links.

The above summary does not represent every embodiment or every aspect of this disclosure. Rather, the above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a perspective view illustration of a representative motor vehicle with an inset view of a front wheel unit supported on a multilink, mid-height front suspension assembly in accordance with aspects of the present disclosure.

FIG. 2 is an aftward-looking perspective-view illustration of a representative multilink, mid-height front suspension assembly in accordance with aspects of the present disclosure.

FIG. 3 is an elevated perspective-view illustration of the representative suspension assembly of FIG. 2 with the wheel unit, stabilizer link, and steering knuckle removed.

FIG. 4 is a plan-view illustration of the representative suspension assembly of FIG. 3.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for instance, by the appended claims.

### DETAILED DESCRIPTION

This disclosure is susceptible of embodiment in many different forms. Representative examples of the disclosure are shown in the drawings and herein described in detail with the understanding that these embodiments are provided as an exemplification of the disclosed principles, not limitations of the broad aspects of the disclosure. To that end, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, the drawings discussed herein may not be to scale and are provided purely for instructional purposes. Thus, the specific and relative dimensions shown in the Figures are not to be construed as limiting.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and permutations thereof, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle, when the vehicle is operatively oriented on a horizontal driving surface.

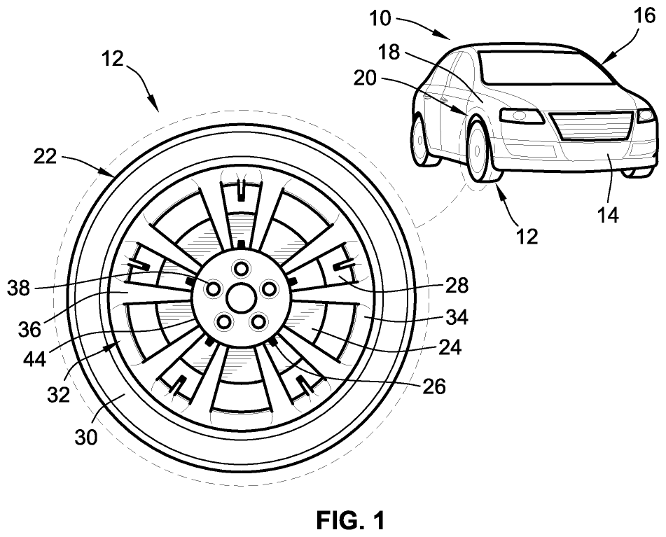

Referring now to the drawings, wherein like reference numbers refer to like features throughout the several views, there is shown in FIG. 1 a perspective-view illustration of a representative automobile, which is designated generally at 10 and portrayed herein for purposes of discussion as a three-box, sedan-style passenger vehicle. The illustrated automobile 10—also referred to herein as “motor vehicle” or “vehicle” for short—is merely an exemplary application with which novel aspects of this disclosure may be practiced. In the same vein, implementation of the present concepts into a front driver-side corner assembly of a rear-wheel drive (RWD) drivetrain layout should also be appreciated as a representative implementation of the novel concepts disclosed herein. As such, it will be understood that facets of the present disclosure may be applied to other corner assemblies, utilized in alternative drivetrain configurations, and incorporated into any logically relevant type of motor vehicle. Lastly, only select components have been shown and will be described in additional detail herein. Nevertheless, the motor vehicles and suspension systems discussed below may include numerous additional and alternative features, and other available peripheral components and hardware, for carrying out the various features and functions of this disclosure.

Mounted proximate a forward end of the automobile 10, e.g., aft of a front bumper fascia 14 and forward of a passenger compartment 16, is a front corner module 12, which is positioned within a wheel well that is defined, in part, by a front fender panel 18 of the vehicle's body 20. As will be described in additional detail below, the front corner module 12 includes front suspension, steering, and braking system components for connecting a wheel unit 22 to the vehicle body 20 within the wheel well of the fender 18. These suspension, steering, and braking systems may take on any commercially available or hereafter developed architectures, including: electromagnetic, hydraulic, and friction (drum or disc) brake system configurations; Ackermann, bell-crank, power-assisted, and by-wire vehicle steering system configurations; and independent or dependent, active or passive, leaf spring, twist-beam, or coil spring, wishbone, trailing-arm or multi-link suspension system configurations, etc. The front corner module 12 of FIG. 1 is generally represented by a brake rotor 24 of a front disc brake assembly and an axle hub-and-bearing assembly 26 of an independent suspension system. A dust cover (or “splash shield”) 28 is interposed between the brake rotor 24 and a knuckle, spindle, strut, etc., of the steering and suspension systems to protect these components from road debris, ice, water, etc.

Wheel unit 22 of FIG. 1 is generally composed of a composite synthetic-rubber tire 30 that circumscribes a metal-composite wheel, designated generally at 32. Irrespective of tire type, whether it be all-season, all-terrain, off-road, low profile, snow, mud, etc., the tire 30 may take on a multilayer toroidal form with an outer tread that increases traction and, thus, vehicle handling. A typical pneumatic radial tire, for example, includes a rubber tread overlaying metallic belts, cap and radial plies, and a main carcass with inextensible beads that seal to the outer perimeter of the wheel 32. The tire 30 may be provided with a Schrader-type check valve for regulating tire pressure. As is common, the tire 30 may mount directly onto the wheel 32 structure and hold air without the need for a separate inner tube.

The metallic wheel 32 may be constructed with an annular barrel 34 that is attached to and circumscribes a central wheel face 36. In a non-limiting example, the wheel barrel 34 and face 36 of FIG. 1 may be a unitary cast or forged weldment formed entirely from a metallic material, such as aluminum 356 alloy for a cast weldment and aluminum 6061 or aluminum 5454 alloy for a forged weldment. A series of spokes is circumferentially spaced equidistantly around, and project radially outward from, a central wheel hub 44 of FIG. 1); the hub 44 and spokes collectively defining the wheel face 36 of the wheel unit 22. The central hub 44 of the wheel 32 and, thus, the wheel assembly 22 is mounted via a circular array of lug nuts 38 onto complementary studs of the hub-and-bearing assembly 26 for common rotation with the rotor 24.

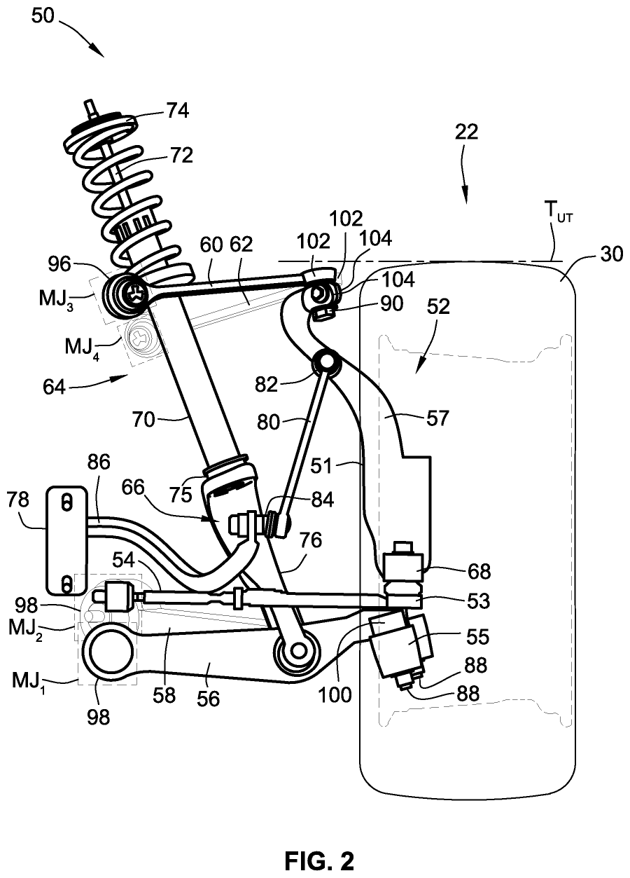

To optimize vehicle ride quality with balanced road handling characteristics, a multilink vehicle suspension system provides controlled relative motion—“jounce” and “rebound”—between the road wheels and load-bearing chassis during vehicle operation. For steerable wheel units, such as front driver-side and passenger-side road wheels, the suspension system also helps to regulate tire camber and caster in order to maintain proper alignment. FIG. 2 illustrates a representative 5-link, mid-arm front suspension assembly 50 that may help to significantly shorten the spindle-length geometry of a mid-arm suspension while also improving vehicle handing by reducing caster trail and scrub change during a steering maneuver. In accord with the depicted example, the suspension assembly 50 is represented herein by: a steering knuckle 52; a tie bar link (TBL) 54; a set of leading and trailing lower control links (LCL) 56 and 58, respectively; a set of leading and trailing upper control links (UCL) 60 and 62, respectively; a shock absorber assembly 64; and a stabilizer link (SL) assembly 66. It will be appreciated that the suspension assembly 50 may include greater, fewer, or alternative components from that which are shown in the drawings, such as a variably pressurized air suspension spring, a helical or leaf-type damper spring, a suspension strut assembly, etc.

In order to steer the vehicle 10 when moving forward or in reverse, tie bar link 54 enables selective swivel of the wheel unit 22 on the steering knuckle 52 relative to the vehicle body 20, which may be a unibody or body-on-frame construction. An outboard end of the elongated tie bar link 54, e.g., the longitudinal end farthest from the vehicle's fore-aft centerline, is mounted to a dedicated TBL swivel joint 68 of the steering knuckle 52. Conversely, an inboard end of the tie bar link 54, e.g., the longitudinal end closest to the vehicle's fore-aft centerline, is mounted to a steering system actuator, such as the steering rack of a rack-and-pinion steering assembly via a tie-rod elbow socket. To allow free rotation in multiple planes, the swivel joint 68 connecting the tie bar 54 to the knuckle 52 may be in the nature of a spherical bearing, such as a high-precision ball joint.

With continuing reference to FIG. 2, the shock absorber assembly 64 helps to absorb and dampen wheel-borne shock impulses generated by a non-homogenous roadway during vehicle operation. The shock absorber assembly 64 is generally composed of a pneumatic or hydraulic cylinder 70 with a reciprocating piston head (not visible) that is slidably movable within a sealed fluid chamber inside of the cylinder 70. An upper mount head 74 movably mounts the piston head to the vehicle chassis via a piston rod 72 that projects through an upper end of the air cylinder 70. A shock yoke 76 couples a lower mount head 75 at a bottom end of the shock absorber cylinder 70 to the leading lower control link 56, e.g., via a U-type swivel joint. With this arrangement, the leading and trailing upper control links 60, 62 are located on fore and aft sides, respectively, of the shock absorber assembly 64, whereas the control link 56 and shock yoke 76 are interposed between the tie bar link 54 and trailing lower control link 58.

To mitigate torsional forces borne by the wheel unit 22 during vehicle operation, an optional stabilizer link assembly 66 extends inboard from the wheel unit 22, downwards from the steering knuckle 52 and upper control links 60, 62, wraps around the forward face of the damper assembly 64, and inserts into a stabilizer bar clamp 78 that is coupled to the vehicle chassis aft of the shock absorber assembly 64. An outboard end of a stabilizer link 80 is pivotably mounted via an upper SL joint 82 (e.g., a horizontal ball joint) to an inboard-facing surface of the steering knuckle 52 adjacent the knuckle mounting points for the upper control links 60, 62. The inboard end of the stabilizer link 80, on the other hand, is coupled via a lower SL joint 84 to a stabilizer bar 86 that rotatably couples the stabilizer link 80 to the stabilizer bar clamp 78.

Functioning as a structural intermediary for the vehicle's steering, suspension, and brake systems, the steering knuckle 52 is characteristically a cast and machined, single-piece metallic structure that physically supports the various components of the front corner module 12. According to the illustrated example, the steering knuckle 52 includes a hollow central hub 51 that rotatably mounts thereto the wheel unit 22 via the axle hub-and-bearing assembly 26. Projecting radially outward from the central hub 51 are three integrally formed mounting arms: a forward-projecting TBL mounting arm 53 with a dedicated horizontal flange buttressing the TBL swivel joint 68 that mounts the tie bar link 54 to the knuckle 52; a downward and inboard-projecting LCL mounting arm 55 with a dedicated horizontal flange buttressing two LCL swivel joints 88, 100 that mount the lower control links 56, 58 to the knuckle 52; and an upward and inboard-projecting UCL mounting arm 57 with a flange buttressing two UCL swivel joints 90, 102 that mount the upper control links 60, 62 to the steering knuckle 52. Similar to the tie bar's swivel joint 68, the control link swivel joints 88, 100 and 90, 102 may be simple spherical bearings, such as high-precision ball joints. Disclosed swivel joint interfaces may alternatively comprise bow tie joints, tee joints, or other suitable mechanical joint configurations.

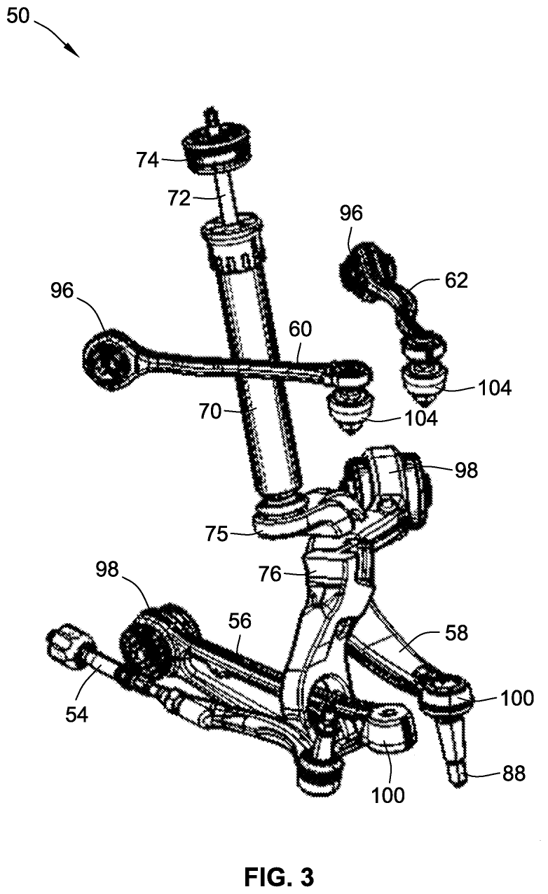

With collective reference to FIGS. 2-4, the four knuckle control links 56, 58, 60, 62 are all located aft of the tie bar link 54 with the upper control links 60, 62 vertically spaced from the lower control links 56, 58. The inboard end of each lower control link 56, 58 mounts to a discrete mounting junction MJ₁ and MJ₂ on the vehicle chassis (e.g., unibody mount or frame rail). Outboard ends of the lower control links 56, 58, in contrast, are mounted via independent LCL swivel joints 88, 100 to the LCL mounting arm 55 projecting obliquely from the lower end of the steering knuckle 52. Likewise, an inboard end of each upper control link 60, 62 mounts to a discrete mounting junction MJ₃ and MJ₄ on the vehicle chassis. Conversely, outboard ends of each control link 60, 62 are mounted via independent swivel joints 90, 102 to the UCL mounting arm 57 projecting obliquely from the upper end of the steering knuckle 52. Simplicity of design and manufacture may necessitate the lower control links 56, 58 mount to a shared flange of a common mounting arm 55 and the upper control links 60, 62 mount to a shared flange of a common mounting arm 55. Optionally, each control link 56, 58, 60, 62 may operatively couple to a distinct mounting arm projecting from the steering knuckle 52.

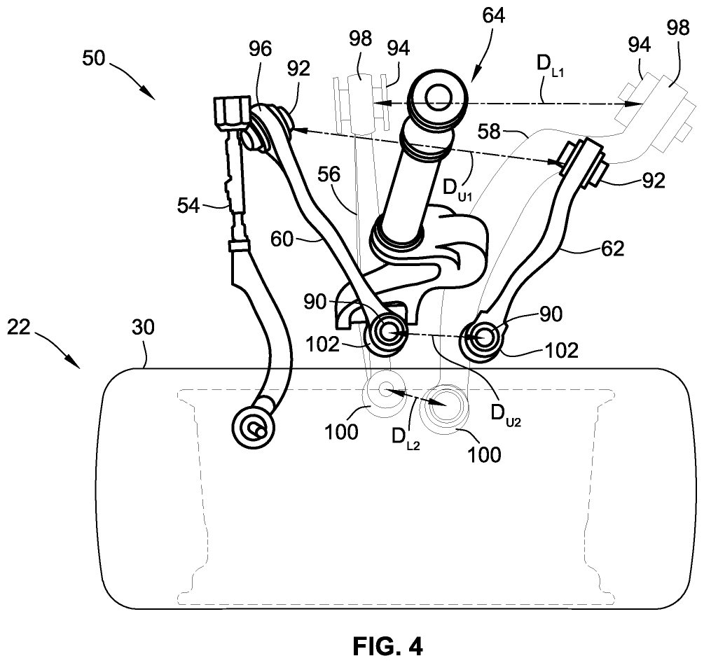

In accord with the representative 5-link suspension assembly 50 of FIGS. 2-4, all four of the control link mounting junctions MJ₁-MJ₄ on the vehicle chassis may constitute independent, plain bushing bearings to allow for vertical displacement between the steering knuckle 52 and vehicle body 20. In particular, the lower mounting junctions MJ₁, MJ₂ and upper mounting junctions MJ₃, MJ₄ may each employ a respective horizontal bushing pin 92 and 94 (FIG. 4) that is secured in a mating U-shaped bracket (not shown). The inboard ends of the lower and upper control links 56, 58, 60, 62 are formed with respective bushing housings 96 and 98 that receive therethrough one of the horizontal bushing pins 92, 94.

Rotational displacement between the steering knuckle 52 and vehicle body 20 may be enabled by control link swivel joints on the steering knuckle 52 that are constructed as independent, plain spherical bearing assemblies. Specifically, each swivel joint employs a respective bearing stud 88, 90 with a threaded bottom end that is mated with a complementary tapered jacket 104 (FIG. 2) that fits into the flange of the corresponding mounting arm 55, 57. The outboard ends of the lower and upper control links 56, 58, 60, 62 include respective bearing sockets 100 and 102 that each nests therein a spherical tip at the top end of one of the bearing studs 88, 90. As shown, each control link 56, 58, 60, 62 is a discrete component that is structurally distinct (e.g., different curvilinear shape and distinct widths and lengths) from the other control links.

To facilitate a 5-link, mid-arm suspension architecture, the outboard ends of the upper control links 60, 62 are spaced from each other a first UCL horizontal distance D_{U1} and the inboard ends of the upper control links 60, 62 are spaced from each other a second UCL horizontal distance D_{U2} that is greater than the first horizontal distance D_{U1} such that the upper control links 60, 62 are arranged in a first V-shaped configuration, as best seen in FIG. 4. At the same time, the outboard ends of the lower control links 56, 58 are spaced from each other a first LCL horizontal distance D_{L1} and the inboard ends of the lower control links 56, 58 are spaced from each other a second LCL horizontal distance D_{L2} that is greater than the first horizontal distance D_{L1} such that the upper control links 56, 58 are arranged in a second V-shaped configuration. As shown, the V-shaped configuration of the upper control links 60, 62 is distinct from the V-shaped configuration of the lower control links 56, 58, namely the inboard horizontal distance D_{U1} is larger than the inboard horizontal distance D_{L1} and the outboard horizontal distance D_{U2} is larger than the outboard horizontal distance D_{L2}. This arrangement allows the upper control links 60, 62 to “wrap around” the shock absorber assembly 64.

It may be desirable to offer originally equipped and after-market automobile features with enlarged tire diameters and lowered front hood designs without packaging conflicts between the control links and wheel well experienced. These options may be enabled by packaging all four control links 56, 58, 60, 62 inboard from the wheel unit 22 with the upper control links 60, 62 located below an upper threshold TUT (FIG. 2) of the tire 30. In particular, the UCL and LCL swivel joints mount the upper and lower control links 56, 58, 60, 62 to the steering knuckle 52 inboard from the wheel unit 22 and below an upper extent of the tire 30. As best seen in FIG. 4, the outboard ends of the upper control links 60, 62 are spaced inboard from the outboard ends of the lower control links 56, 58. In addition, the inboard ends of the upper control links 60, 62 are spaced outboard from the inboard ends of the lower control links 56, 58.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A multilink suspension assembly for a motor vehicle, the motor vehicle including a vehicle chassis and a wheel unit with a tire, the multilink suspension assembly comprising:
a steering knuckle configured to rotatably mount thereon the wheel unit;
a tie bar link (TBL) mounted to a TBL swivel joint of the steering knuckle;
a plurality of lower control links (LCL) located aft of the tie bar link, each of the lower control links having a respective LCL inboard end configured to mount to a respective LCL mounting junction on the vehicle chassis and a respective LCL outboard end mounted to a respective LCL swivel joint at a lower end of the steering knuckle; and
a plurality of upper control links (UCL) located aft of the tie bar link and vertically spaced from the lower control links, each of the upper control links having a respective UCL inboard end configured to mount to a respective UCL mounting junction on the vehicle chassis and a respective UCL outboard end mounted to a respective UCL swivel joint at an upper end of the steering knuckle,
wherein the LCL swivel joints and the outboard ends of the lower control links are located inboard from a diametric centerline of the wheel unit and the tire; and
wherein the UCL swivel joints and the outboard ends of the upper control links are located inboard from the wheel unit and the tire and are located below an upper extent of the tire.

2. The multilink suspension assembly of claim 1, wherein the UCL outboard ends of the upper control links are spaced from each other a first UCL horizontal distance.

3. The multilink suspension assembly of claim 2, wherein the UCL inboard ends are spaced from each other a second UCL horizontal distance greater than the first UCL horizontal distance such that the upper control links are arranged in a first V-shaped configuration.

4. The multilink suspension assembly of claim 3, wherein the LCL outboard ends of the lower control links are spaced from each other a first LCL horizontal distance.

5. The multilink suspension assembly of claim 4, wherein the LCL inboard ends are spaced from each other a second LCL horizontal distance greater than the first LCL horizontal distance such that the upper control links are arranged in a second V-shaped configuration.

6. The multilink suspension assembly of claim 1, wherein the UCL outboard ends of the upper control links are spaced inboard from the LCL outboard ends of the lower control links.

7. The multilink suspension assembly of claim 6, wherein the UCL inboard ends of the upper control links are spaced outboard from the LCL inboard ends of the lower control links.

8. The multilink suspension assembly of claim 1, wherein the LCL and UCL mounting junctions on the vehicle chassis each includes a respective horizontal bushing pin, and wherein the LCL and UCL inboard ends of the lower and upper control links each includes a respective bushing housing configured to receive therein a respective one of the horizontal bushing pins.

9. The multilink suspension assembly of claim 1, wherein the LCL and UCL swivel joints on the steering knuckle include respective bearing studs, and wherein the LCL and UCL outboard ends of the lower and upper control links each includes a respective bearing socket configured to receive therein a respective one of the bearing studs.

10. The multilink suspension assembly of claim 1, wherein the steering knuckle includes a central hub configured to rotatably mount thereto the wheel unit via an axle hub assembly.

11. The multilink suspension assembly of claim 10, wherein the steering knuckle further includes TBL, LCL, and UCL mounting arms projecting radially outward from the central hub, the TBL mounting arm including a horizontal TBL flange with the TBL swivel joint mounting thereto the tie bar link, the LCL mounting arm including a horizontal LCL flange with the LCL swivel joints mounting thereto the lower control links, and the UCL mounting arm including a horizontal UCL flange with the UCL swivel joints mounting thereto the upper control links.

12. The multilink suspension assembly of claim 1, further comprising a stabilizer link (SL) with an SL outboard end thereof pivotably mounted to the steering knuckle adjacent to the UCL swivel joints, the stabilizer link extending downward from the upper control links.

13. The multilink suspension assembly of claim 1, further comprising:
a shock absorber assembly;
a shock yoke coupling a bottom end of the shock absorber assembly to one of the lower control links,
wherein each of the upper control links is located on a respective side of the shock absorber assembly.

14. The multilink suspension assembly of claim 1, wherein the upper and lower control links are structurally distinct and discrete from one another.

15. A motor vehicle comprising:
a vehicle chassis;
a plurality of wheel units each including a hub and a tire mounted on the hub;
a prime mover mounted on the vehicle chassis and operable to drive one or more of the wheel units to thereby propel the motor vehicle; and
a plurality of multilink suspension assemblies each including:
a steering knuckle rotatably mounting thereon a respective one of the wheel units;
a tie bar link (TBL) mounted to a TBL swivel joint of the steering knuckle;
a pair of lower control links (LCL) located aft of the tie bar link relative to the vehicle chassis, each of the lower control links having a respective LCL inboard end mounted to a respective LCL mounting junction on the vehicle chassis and a respective LCL outboard end mounted to a respective LCL swivel joint at a lower end of the steering knuckle; and
a pair of upper control links (UCL) located aft of the tie bar link and vertically spaced from the lower control links, each of the upper control links having a respective UCL inboard end mounted to a respective UCL mounting junction on the vehicle chassis and a respective UCL outboard end mounted to a respective UCL swivel joint at an upper end of the steering knuckle,
wherein the LCL swivel joints and the outboard ends of the lower control links are located inboard from a diametric centerline of the wheel unit and the tire; and
wherein the UCL swivel joints and the outboard ends of the upper control links are located inboard from the wheel unit and the tire and are located below an upper extent of the tire.

16. A method of manufacturing a multilink suspension assembly for a motor vehicle, the motor vehicle including a vehicle chassis and a wheel unit with a tire, the method comprising:
mounting a tie bar link (TBL) to a TBL swivel joint of a steering knuckle, the steering knuckle configured to rotatably mount thereon the wheel unit;
mounting a plurality of lower control links (LCL) to the steering knuckle aft of the tie bar link, each of the lower control links having a respective LCL inboard end configured to mount to a respective LCL mounting junction on the vehicle chassis and a respective LCL outboard end mounted to a respective LCL swivel joint at a lower end of the steering knuckle; and
mounting a plurality of upper control links (UCL) to the steering knuckle aft of the tie bar link and vertically spaced from the lower control links, each of the upper control links having a respective UCL inboard end configured to mount to a respective UCL mounting junction on the vehicle chassis and a respective UCL outboard end mounted to a respective UCL swivel joint at an upper end of the steering knuckle,
wherein the LCL swivel joints and the outboard ends of the lower control links are located inboard from a diametric centerline of the wheel unit and the tire; and
wherein the UCL swivel joints and the outboard ends of the upper control links are located inboard from the wheel unit and the tire and are located below an upper extent of the tire.

17. The method of claim 16, wherein the UCL outboard ends of the upper control links are spaced from each other a first UCL horizontal distance and the UCL inboard ends are spaced from each other a second UCL horizontal distance greater than the first UCL horizontal distance such that the upper control links are arranged in a first V-shaped configuration.

18. The method of claim 16, wherein the LCL outboard ends of the lower control links are spaced from each other a first LCL horizontal distance and the LCL inboard ends are spaced from each other a second LCL horizontal distance greater than the first LCL horizontal distance such that the upper control links are arranged in a second V-shaped configuration.

19. The method of claim 16, wherein the UCL outboard ends of the upper control links are spaced inboard from the LCL outboard ends of the lower control links and the UCL inboard ends of the upper control links are spaced outboard from the LCL inboard ends of the lower control links.

20. The method of claim 16, wherein the steering knuckle includes a central hub with TBL, LCL, and UCL mounting arms projecting radially outward from the central hub, the TBL mounting arm including a horizontal TBL flange with the TBL swivel joint mounting thereto the tie bar link, the LCL mounting arm including a horizontal LCL flange with the LCL swivel joints mounting thereto the lower control links, and the UCL mounting arm including a horizontal UCL flange with the UCL swivel joints mounting thereto the upper control links.
